(19) United States
(12) Patent Application Publication
(10) Pub. No.: US 2010/0162414 A1
(43) Pub. Date: Jun. 24, 2010

(54) Digital Rights Management for Differing Domain-Size Restrictions

(75) Inventor: Alexander Medvinsky, San Diego, CA (US)

Correspondence Address: Motorola, Inc.;Law Department, 1303 East Algonquin Road, 3rd Floor, Schaumburg, IL, 60196, US

(73) Assignee: General Instrument Corporation, Horsham, PA (US)

(21) Appl. No.: 12/342,202

(22) Filed: Dec. 23, 2008

(51) Int. Cl. G06F 21/00

(52) U.S. Cl. 726/31

(57) ABSTRACT

A digital rights management system includes a domain authority controller that manages different domain-size restrictions for different content sources. A subdomain is created for each content source and has a corresponding domain-size restriction. Different domain-size restrictions for the content sources are stored along with the number of devices registered for each subdomain. A domain authority controller is operable to register a device with a subdomain if the corresponding domain-size restriction is not violated. A device is allowed to use content from a content source if it is registered with the subdomain for the content source.

### RELATED APPLICATIONS

The present invention is related to U.S. Pat. No. 7,243,366, “Key Management Protocol and Authentication System for Secure Internet Protocol Rights Management Architecture,” filed on Mar. 4, 2002 and U.S. Patent Publication No. 20060242069 titled, “Digital Rights Management for Local Recording and Network Distribution,” filed on Dec. 29, 2005. The disclosures of the above-identified patent and patent application are incorporated by reference in their entireties.

### BACKGROUND

The nature of digital media content presents significant challenges with respect to the protection and management of these rights, referred to as Digital Rights Management (DRM). It is difficult for sources of propriety digital media content to protect against unauthorized copying. This problem stems from a lack of capabilities of maintaining and enforcing copy protection according to different DRM rules corresponding to different sources of digital media content.

Consumers of digital media content desire content from multiple sources. Typically, each source of digital media content defines its own “domain-size restriction.” A domain-size restriction of a particular source is the total number of devices permitted to share digital media content from the particular source. Given the varying domain-size restrictions, it is difficult for users to 1) share digital media content from different sources with as many digital media content devices as is authorized by each particular source and 2) avoid sharing digital media content with more devices in total than that which is authorized by each source.

### BRIEF DESCRIPTION OF THE DRAWINGS

Features of the present invention will become apparent to those skilled in the art from the following description with reference to the figures, in which:

FIG. 1 illustrates a simplified block diagram of a DRM system configured to manage the different domain-size restrictions of different content sources, according to an embodiment of the invention;

FIG. 2 illustrates a flow diagram of a method for managing different domain-size restrictions, according to an embodiment of the present invention;

FIG. 3 illustrates a flow diagram of a method for obtaining rights to play content, according to an embodiment of the present invention; and

FIG. 4 shows a block diagram of a computer system 400 that may be used in the DRM system, according to an embodiment of the invention.

### DETAILED DESCRIPTION

For simplicity and illustrative purposes, the present invention is described by referring mainly to exemplary embodiments thereof. In the following description, numerous specific details are set forth to provide a thorough understanding of the present invention. However, it will be apparent to one of ordinary skill in the art that the present invention may be practiced without limitation to these specific details. In other instances, well known methods and structures have not been described in detail to avoid unnecessarily obscuring the present invention.

Embodiments of the present invention provide a flexible and secure system for copying and using content from different content sources among devices belonging to one consumer. For example, embodiments of the present invention provide for copying digital multimedia content having different DRM Systems to different devices of the consumer. As is known in the art, DRM systems employ access control technologies to provide copy protection. Some DRM systems use a standard (e.g., Open Mobile Alliance (OMA) DRMv2), while others (e.g., Windows Media Digital Rights Management (WMDRM), MOTOROLA's Internet Protocol Rights Management (IPRM)) are proprietary. The consumer may be a single user or multiple users, such as a family or business. The devices may be devices that use the content. The devices that use the content may include a personal media player, personal computer, set top box, media server, cell phone, etc. Using content may include copying the content, playing the content, and/or executing the content. Content is data. Content may be digital multimedia content, such as songs, ringtones, movies, images, etc. Content may be computer programs, such as applications.

A content source provides content to the consumer. The content may be downloaded from a content source via a network or distributed through other channels to the consumer. Each content source may have a different DRM systems, and thus content from each different source may use a different DRM system. In most situations, all or most of the content from one source has the same DRM system, but different content from the same source may have different DRM systems.

One DRM component that may differ among sources is domain-size restriction. This includes limitations on the number of devices belonging to one consumer that can maintain and play their own copies of the content. A domain is a group of devices authorized to share the same content, typically because they belong to the same user or family unit. Different content sources may have different domain-size restrictions. According to an embodiment, a subdomain is created for each content source. The subdomain identifies the domain-size restriction for the content source, number of devices registered with the content source (which cannot exceed the domain-size restriction), device IDs of the registered devices, and possibly other information related to the content source, such as registered devices and content from the content source.

Because it may be confusing for the consumer to keep track of the different domain-size restrictions for different content sources and still comply with the different domain-size restrictions, a less desirable system may include fixing the domain-size to a common minimum among the different domain-size restrictions to avoid copying content onto more devices than legally/contractually allowed. However, embodiments of the present invention enable a consumer to make the maximum number of allowed copies of content from different sources without violating the different domain-size restrictions of the different sources.

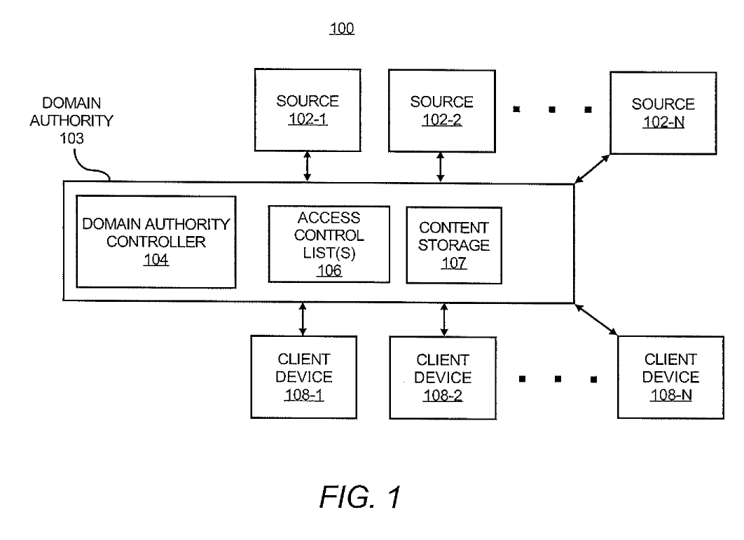

FIG. 1 illustrates the simplified block diagram of a DRM system 100 configured to manage different domain-size restrictions of different content sources, according to an embodiment of the invention. FIG. 1 shows multiple content sources 102, shown as 102-1 through 102-N, a domain authority 103 (which may include one or more computer systems), a domain authority controller 104, access control lists 106, content storage 107, and client devices 108, shown as 108-1 through 108-N (wherein N is a positive integer). The client devices 108 may be consumer or end-user devices that use content, such as a personal media player, personal computer, set top box, media server, cell phone, etc.

The content sources 102 may be any source of content. Each of the sources 102 has an independent and possibly has a different DRM system. In addition, each of the sources 102 may have a different domain-size restriction.

The domain authority 103 is configured to obtain content from each of the sources 102 and enforce the DRM systems for each source. The domain authority 103 provides a generic DRM protection system to enforce all the different DRM rights for content from the different sources 102. In this regard, the domain authority 103 manages content consumption within its domain of client devices 108. In particular, the domain authority 103 manages the different domain-size restriction of the sources 102.

For example, the domain authority 103 authorizes use of content, which may include copying and playing, from any of the sources 102 upon determining that the maximum number of devices authorized to obtain content from that source will not be exceeded. Conversely, the domain authority 103 denies use of content from any of the sources 102 upon determining that the maximum number of devices authorized to obtain content from that source will be exceeded. In addition, the domain authority 103 is configured to provide the client devices 108 with the ability to use content from the sources 102 upon the determination that domain-size restrictions are not violated, i.e., not exceeded. In one embodiment, this includes providing the client devices 108 with tickets which authorize the client devices 108 to copy and play content. The tickets may provide authentication and decryption keys for transferring content keys and rights between devices.

The domain authority controller 104 performs the DRM management functions, including managing the domain-size restrictions. The domain authority controller 104 may be software hosted and executed by a computer system. The client devices 108 may include client software that allows the client devices 108 to interact with the domain authority controller 104 to use content. For example, the domain authority controller 104 is configured to control obtaining content from the different sources 102, and enforce the different domain-size restrictions. As another example, the domain authority controller 104 is configured to control the authorization or denial of access and use of content obtained from different sources 102 as described herein. Yet another example includes that the domain authority controller 104 writing and reading content into and out of memory or other data storage for client devices 108.

The access control lists 106 store information for each subdomain. According to an embodiment, a subdomain is created for each content source. The subdomain identifies the domain-size restriction for the content source, number of devices registered in the subdomain (which cannot exceed the domain-size restriction), device IDs of the registered devices, and possibly other information related to the content source, registered devices and content from the content source. Devices registered in the subdomain can use content from the content source for the subdomain. The subdomain information is stored in an access control list for each subdomain. The access control lists 106 keep track of the number of devices registered in each subdomain.

The information for the access control lists 106 may be stored in a database. The domain authority controller 104 queries the access control lists 106 to determine whether a domain-size restriction would be violated if a new device were to be registered in a subdomain, modifies the subdomains to add or remove devices, and queries the access control lists to grant tickets to devices to allow them to use content from sources 102.

The content storage 107 stores content from the sources 102. The content storage 102 may be in the domain authority 103 or in another computer system, such as a separate media server. In one example, the client devices 108 present tickets to the system including or managing the content storage 107 to receive content stored in the content storage 107. The content storage may include known data storage devices.

It will be apparent that the DRM system 100 may include additional elements not shown and that some of the elements described herein may be removed, substituted and/or modified without departing from the scope of the local DRM security system 100. It should also be apparent that one or more of the elements described in the embodiment of FIG. 1 may be optional.

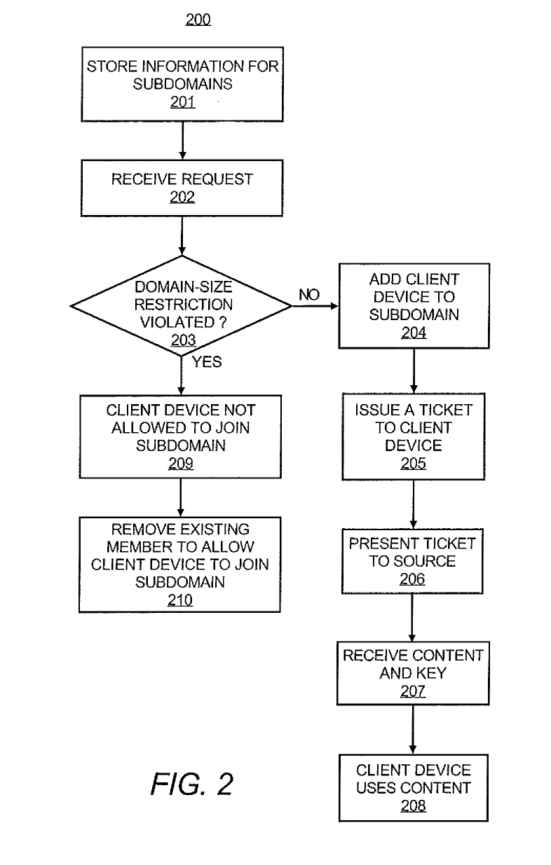

An example of a method in which the DRM system 100 may be employed for managing different domain-size restrictions of different content sources will now be described with respect to the following flow diagram of the method 200 depicted in FIG. 2. It should be apparent to those of ordinary skill in the art that the method 200 represents a generalized illustration and that other steps may be added or existing steps may be removed, modified or rearranged without departing from the scopes of the method 200. Also, the method 200 is described with respect to the system 100 by way of example and not limitation, and the method 200 may be used in other systems.

Some or all of the operations set forth in the method 200 may be contained as one or more computer programs stored in any desired computer readable medium and executed by a processor on a computer system. Exemplary computer readable media that may be used to store software operable to implement the present invention include but are not limited to conventional computer system RAM, ROM, EPROM, EEPROM, hard disks, or other data storage devices.

FIG. 2 illustrates the flow diagram of the method 200 for managing different domain-size restrictions of different DRM sources as described herein, according to an embodiment of the present invention.

At step 201, information for subdomains is stored. A subdomain is created for each content source. The subdomain identifies the domain-size restriction for the content source, number of devices registered with the content source (which cannot exceed the domain-size restriction), device IDs of the registered devices, and possibly other information related to the content source, registered devices and content from the content source. This information is stored in an access control list for each subdomain. The access control lists 106 keep track of the number of devices registered in each subdomain.

At step 202, the domain authority controller 103 receives a request for a device to join a subdomain. This request may come from a user through a an administrative screen, or this request may actually be a request to use content from one of the content sources 102. However, a client device must be member of the subdomain to use the content. If the client device is already a member, which may be determined by querying the access control list for the subdomain, the client device is allowed to use the content from the content source. The domain authority controller 103 or other software may generate a user interface that allows a user to edit subdomains and make requests. User authentication may also be performed to ensure the user making the edits to a subdomain is authorized.

At step 203, the domain authority controller 103 determines whether the domain-size restriction for the content source is violated if the client device joins the subdomain. For example, the content source 102-1 restricts the subdomain size to 4 client devices. If only three client devices are registered with the subdomain, then the domain-size restriction for the subdomain would not be violated if the client device 108-1 also joins the subdomain. If, however, 4 client devices were already registered in the subdomain, the domain-size restriction would be exceeded and violated if the client device 108-1 were to join the subdomain. In this case, the domain authority controller 103 would not allow the client device 108-1 to join the subdomain for the content source 102-1, and the client device 108-1 would not be allowed to use content from the content source 102-1, which may be stored in the content storage 107. A device could be removed from the subdomain, however, to allow the client device 108-1 to join the subdomain and use content from the content source 102-1. Once a device is removed from a domain and its current ticket expires, it will no longer be able to access the content from the corresponding content source. In one example, the information in the access control lists 106 is used by the domain authority controller 103 to determine whether a domain-size restriction would be violated.

At step 204, if the domain-size restriction is not violated for the subdomain, the client device is allowed to join the subdomain. The client device is added to the access control list for the subdomain.

At step 205, the domain authority controller 103 issues a ticket to the client device to allow the client device to use content from the content source. The ticket is used for transferring content keys and rights between devices. For example, at step 206, the client device presents the ticket to another device, (e.g., source device) which may be storing the content or otherwise has the ability to provide the client device with the content. The client device also sends a request to the source device for the content. In IPRM, the request is called a Key Request. In response to the request, the client device gets back the content key and content (if the content is not already with the client device) as well as content rights at step 207. The content key and content rights are returned in an IPRM message called Key Reply, where the content key is encrypted with the session key from the ticket and the content rights are authenticated (with a Message Authentication Code) using that same session key. Then, the client device can play the content. It should be noted that the request and transfer of the actual encrypted content is separate from the IPRM Key Request/Key Reply transaction. The encrypted content transfer is not part of IPRM and can be any conventional file transfer protocol (e.g., FTP) or content streaming protocol (e.g., RTP).

At step 208, the client device uses the content. This may include obtaining the content, ticket and content rights as described above in order to be able to play the content or execute the content if the content is a computer program.

At step 209, if the domain-size restriction is violated, the request is denied, and the client device is not allowed to join the subdomain. At step 210, a client device may be removed from the subdomain to allow the new client device to join the subdomain.

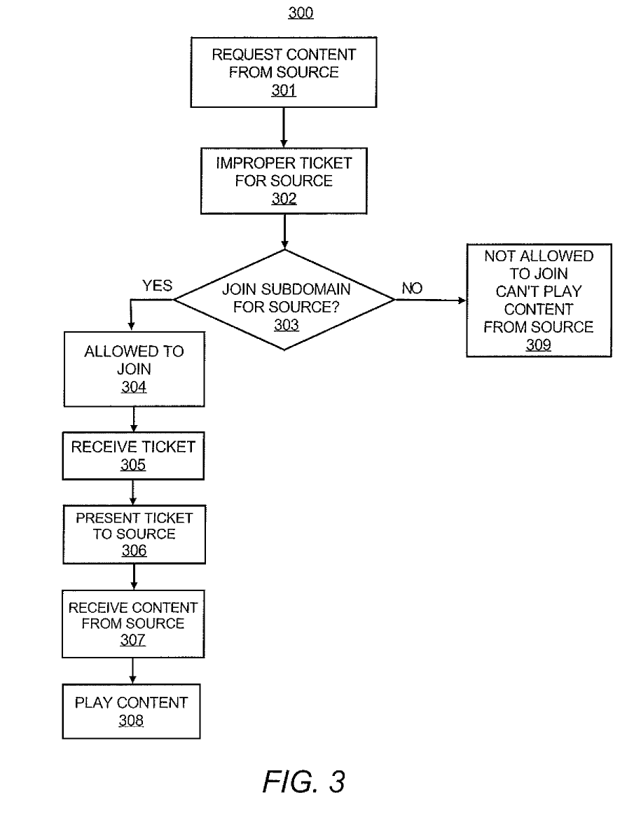

As described with respect to step 206, a client device obtains a ticket and then presents that ticket to another device to get the content key and content rights, which are encrypted with the session key in the ticket. FIG. 3 is a flow chart of a method 300 describing the case when the client device does not have a proper ticket to play the content with the authorization for a particular content source. Assume the client device 108-1 is trying to get and play content from the source 102-1 shown in FIG. 1. At step 301, client device 108-1 requests content from the source 102-1. The request does not have the correct ticket with the authorization for the source 102-1. In this case, the client device 108-1 might be added to the domain of the source 102-1, and then the client device 108-1 has to go back to the domain authority to get an updated ticket that shows the client device 108-1 has access to the source 102-1. Then the client device 108-1 would have to re-request the content with the new ticket from the source 102-1. Alternatively, the sub-domain for the source 102-1 is full and so the client device 108-1 is denied access to the content. This is further described in the following steps.

At step 302, the client device 108-1 receives a response from the source 102-1 indicating the request is rejected, for example, for failure to provide a proper ticket for the source 102-1.

At step 303, steps from the method 200 are performed to determine whether the client device 108-1 can join the subdomain for the source 102-1.

If the domain-size restriction for the sudomain for the source 102-1 is not violated if the client device 108-1 joins, then the client device 108-1 is allowed to join a new sub-domain of the content source 102-1, at step 304. The step to join a sub-domain can be done manually, e.g., a user adds a new content source for a device through an administrative screen interface, or it could be done automatically based on a message sent to the domain authority controller when a device attempts to request content from a new source.

At step 305, and the client device 108-1 receives a ticket that includes authorization for the subdomain of the source 102-1. The domain authority controller may send the ticket to the client device 108-1 for step 305.

At step 306, the client device 108-1 presents the ticket from step 305 to the source 102-1. At step 307, the client device 108-1 receives the content and content key, and then the client device 108-1 can play the content at step 308.

At step 309, if the domain-size restriction for the sudomain for the source 102-1 is violated if the client device 108-1 joins as determined at step 303, then the client device 108-1 is not allowed to join the subdomain and cannot play content from the source 102-1.

The system 100 and the methods 200 and 300 may utilize an IPRM home key distribution center (KDC) as the Domain Authority Controller (104). This is described in U.S. patent application Ser. No. 11/321,210, incorporated by reference above and with the “Motorola IP Rights Management (IPRM) System Electronic Security Broker (ESB) Protocol,” Version 1.1, dated Oct. 17, 2007, hereby incorporated by reference in its entirety.

For example, the system 100 is part of a complete end-to-end scalable DRM system for storage, delivery and in-home distribution of digital content over IP networks using standard protocols such as Real-time Transport Protocol (“RTP”) or IP-encapsulated MPEG-2 Transport Stream, or traditional MPEG-2 networks. The systems are employed to protect digital content and to enforce DRM and copy protection rules for content added to the network and for content once within the network. A typical use for such systems would be an in-home media hub where protected content is downloaded and distributed.

Internet Protocol Rights Management (IPRM) system allows content owners and service providers to deliver content in a secure manner so that the content owner's rights are protected, and business models and contracts enforced, while simultaneously providing end-users such as consumers with seamless and easy-to-use content consumption controls. IPRM provides a mechanism for receiving content from one security domain, re-encrypting that content uniquely for a receiving device, persistently storing that content, and playing back that content at a later time to and within another security domain. IPRM also provides the ability to stream the persistently-stored content from the initial receiving device to another device that has been authenticated as part of the home network. This allows a media server, e.g., a dual-tuner set-top box (“STB”) with hard drive, to deliver recorded content to any TV in the house by streaming to media clients such as STBs. Of course, it is noted that while a home network is described, extensions to a business or other such local network are analogous. For the purpose of this invention, IPRM is used only for protecting content that is exchanged between authorized devices within a home domain.

One of the devices, typically a PDR, Home Gateway, STB, etc., in the home of a user, serves as a media hub or server. This device serves as the Home KDC to provision other IPRM devices in the home to establish a trusted IPRM domain. An authentication service described below is used to then provision other devices into the trusted domain using their IPRM certificates. A key management service is used to distribute content keys within the authorized home network.

Optionally, at least one device within the home network is capable of authenticating directly with an external server. This device is designated as the IPRM gateway and is responsible for external authentication and for obtaining Certificate Revocation Lists (“CRLs”) used to validate status of device certificates (to make sure they have not been revoked, e.g., due to reported misuse of a device). This device may be the same as the Home KDC. This configuration is necessary when the content provider (e.g. cable head-end) needs a certain level of control, such as enabling the recording functions, controlling the home domain size or which device may join the secure home network, etc.

The components of the IPRM system can be grouped into subsystems, each of which is described in greater detail below. These subsystems interact with other devices throughout the system, including STBs and their accompanying display devices, to share the content resident within or sent to the IPRM system. These subsystems include a provisioning and ticket management subsystem and a key management subsystem. The provisioning subsystem allows new devices to obtain authorization to share content within the home domain. As described in the embodiments herein this may include registering with a subdomain. The ticket management subsystem allows tickets to be used to allow access to content, and is primarily represented by a KDC, which has two components: an authentication service (“AS”) for authentication of users and granting of the initial ticket, and a ticket granting service (“TGS”) for issuing tickets for specific services. The main function of the KDC is to keep track of all the provisioned clients and servers in a system and their associated authorizations for sharing protected content. Additionally, the KDC authenticates client devices and issues tickets for those client devices to use during client-server communications. Certain additional details of the implementation of such subsystems are described in the IPRM protocol. The same mechanism is used to establish the trusted domain in the home network, possibly simplified by combining the AS and TGS service.

In one embodiment, the system 100 may be configured for an advanced consumer. An advanced consumer, for example, may want to switch one or more content sources 102 from a first client device 108-1 to a second client device 108-2. The system 100 may provide a home administrative GUI (graphical user interface) for the consumer to request to add or remove client devices from subdomains.

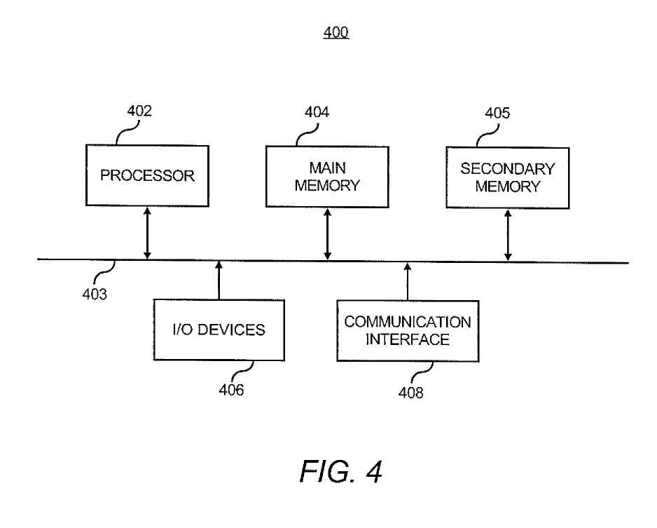

FIG. 4 shows the block diagram of a computer system 400 that may host or be a platform for one or more of the components of the system 100. The computer system 400 may also be used to execute one or more computer programs performing the methods, steps and functions described herein. The computer system 400 may include one or more of the components described below.

The computer system 400 includes a processor 402, providing an execution platform for executing software. Commands and data from the processor 402 are communicated over a communication bus 404. The system 400 also includes a main memory 404, such as a Random Access Memory (RAM), where software may reside during runtime, and a secondary memory 408. The secondary memory 405 may include, for example, a nonvolatile memory where a copy of software is stored. In one example, the secondary memory 405 also includes ROM (read only memory), EPROM (erasable, programmable ROM), EEPROM (electrically erasable, programmable ROM), and other data storage devices, include hard disks.

The system 400 includes I/O devices 406. The I/O devices may include a display and/or user interfaces comprising one or more I/O devices 407, such as a keyboard, a mouse, a stylus, speaker, and the like. A communication interface 408 is provided for communicating with other components. The communication interface 408 may be a wired or a wireless interface. The communication interface 408 may be a network interface.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, wherein the invention is intended to be defined by the following claims—and their equivalents—in which all terms are mean in their broadest reasonable sense unless otherwise indicated.

What is claimed is:

1. A digital rights management (DRM) system comprising:
data storage storing domain-size restrictions for each of multiple content sources, each domain-size restriction indicating a maximum number of devices in a domain that can share content from the content source; and
a domain authority controller operable to determine whether the domain-size restriction for a source of the multiple sources is violated if a device is allowed to use content from the source based on the stored domain-size restriction for the source, and
the domain authority controller is further operable to register the device with a subdomain for the source if the domain-size restriction for the source is not violated, wherein the device is allowed to use the content from the source if the device is registered with the subdomain for the source.

2. The DRM system of claim 1, wherein the domain authority controller is operable to deny registration of the device with the subdomain if the domain-size restriction for the source is violated.

3. The DRM system of claim 1, wherein the domain authority controller is operable to create a subdomain for each source and store information for the subdomain in the data storage, wherein the information includes the domain-size restriction, number of devices registered in the subdomain, and an ID of each device registered in the subdomain.

4. The DRM system of claim 3, wherein a device is operable to register with multiple subdomains.

5. The DRM system of claim 3, wherein the domain authority controller is operable to receive a ticket request from the device already registered in the domain, determine the list of subdomains with which the device is registered, and provide the device with a list of authorized subdomain IDs, wherein the ticket is operable to be presented by the device to receive and use the content associated with authorized subdomains corresponding to authorized content sources.

6. The DRM system of claim 5, wherein the device is operable to present the ticket to a first content source of the content sources, and the first content source determines if the ticket includes a correct subdomain ID corresponding to the first content source.

7. The DRM system of claim 6, wherein if the first the ticket includes the correct subdomain ID corresponding to the first content source, the first content source sends a content key, content rights and requested content to the device.

8. The DRM system of claim 7, wherein the content key is encrypted with a session key from the ticket and the content rights are authenticated using the session key from the ticket.

9. The DRM system of claim 3, wherein the domain authority controller is operable to modify a subdomain membership to remove a device from the subdomain or add a device to the subdomain in response to a user request.

10. The DRM system of claim 1, wherein the multiple content sources have different domain-size restrictions.

11. The DRM system of claim 1, wherein the domain authority controller is hosted by a computer system.

12. A method for enforcing different domain-size restrictions of multiple content sources, the method comprising:
for each content source of the multiple content sources, storing a domain-size restriction indicating a maximum number of devices in a domain that can share content from the content source;
determining whether the domain-size restriction for a content source of the multiple content sources is violated if a new device is allowed to use content from that content source based on the stored domain-size restriction for the source; and
registering the device with a subdomain for the content source if the domain-size restriction for the content source is not violated, wherein the device is allowed to use the content from the content source if the device is registered with the subdomain for the content source.

13. The method of claim 12, further comprising:
denying registration of the device with the subdomain if the domain-size restriction for the content source is violated.

14. The method of claim 12, further comprising:
creating a subdomain for each content source; and
storing information for each subdomain, wherein the information includes the domain-size restriction, number of devices registered in the subdomain, and an ID of each device registered in the subdomain.

15. The method of claim 14, further comprising:
receiving a ticket request from the device;
determining a complete list of subdomains with which the device is registered; and
providing the device with a ticket that includes a list of authorized subdomain IDs corresponding to content sources for which the device is authorized to receive and use content.

16. The method of claim 14 further comprising:
registering a device with multiple subdomains.

17. The method of claim 14, further comprising:
modifying a subdomain of the subdomains to remove a device from the subdomain or add a device to the subdomain in response to a user request.

18. The method of claim 12, wherein the multiple content sources have different domain-size restrictions.

19. A computer readable storage medium storing at least one computer program that when executed performs a method for enforcing different domain-size restrictions of multiple content sources, the method comprising:
for each content source of the multiple content sources, storing a domain-size restriction indicating a maximum number of devices in a domain that can share content from the content source;
determining whether the domain-size restriction for a content source of the multiple content sources is violated if a new device is allowed to use content from that content source based on the stored domain-size restriction for the source; and
registering the device with a subdomain for the content source if the domain-size restriction for the content source is not violated, wherein the device is allowed to use the content from the content source if the device is registered with the subdomain for the content source.

20. The computer readable medium of claim 19, wherein the method further comprises:
denying registration of the device with the subdomain if the domain-size restriction for the source is violated.
